(19) United States
(12) Patent Application Publication
(10) Pub. No.: US 2021/0170821 A1
(43) Pub. Date: Jun. 10, 2021

(54) METHOD AND DEVICE FOR ASCERTAINING A RELATIVE ANGLE BETWEEN TWO VEHICLES

(71) Applicant: Robert Bosch GmbH, Stuttgart (DE)

(72) Inventors: Elmar Staudacher, Esslingen (DE); Katharina Axtmann, Stuttgart (DE); Ulf Niebling, Stuttgart (DE)

(21) Appl. No.: 16/768,328

(22) PCT Filed: Nov. 29, 2018
(86) PCT No.: PCT/EP2018/082932

§ 371 Date: May 29, 2020

(30) Foreign Application Priority Data
Dec. 18, 2017 (DE) 10 2017 223 098.3

(51) Int. Cl. B60D 1/64; B62D 13/06

(52) U.S. Cl. CPC B60D 1/64; B60D 1/245; B62D 13/06

(57) ABSTRACT

A method for ascertaining a relative angle between a first longitudinal axis of a towing vehicle and a second longitudinal axis of a vehicle that is mechanically coupled to the towing vehicle, including: detecting a light unit situated at the vehicle using a camera unit situated at the towing vehicle to obtain image information of the light unit; recognizing the light unit in the obtained image information, using an optical signal that is emitted by the detected light unit to obtain position information of the light unit, the position information representing a spatial position of the light unit in the image information relative to a defined reference point; ascertaining the relative angle between the first longitudinal axis of the towing vehicle and the second longitudinal axis of the vehicle, using the position information of the detected light unit; and emitting a signal as a function of the ascertained relative angle.

### FIELD

The present invention relates to a method for ascertaining a relative angle between a first longitudinal axis of a towing vehicle and a second longitudinal axis of a vehicle that is mechanically coupled to the towing vehicle, and a control unit.

### BACKGROUND INFORMATION

In present-day motor vehicles, legally required outside mirrors are used which allow the driver to recognize the rearward traffic, and, thus, to correspondingly plan his/her driving behavior, for example for a passing operation. There are now first demonstration models and prototypes that replace the conventional mirror with a mirror replacement system or a digital mirror system. This system is made up primarily of one or multiple cameras that are laterally mounted in the exterior vehicle area and that optically detect the rearward traffic. The external information is provided to the driver via a display situated in the vehicle interior.

In present-day freight forwarding logistics yards, the maneuvering and parking of trucks and towing machines take place manually by drivers, usually using signalers. In the future it is anticipated that there will be fully automatic logistics yards in which the trucks may be moved autonomously, i.e., without drivers, and may park automatically (so-called “yard maneuvering”). In particular, backing up and automatically parking a truck with a trailer represent a major challenge.

Articulation angle sensors for ascertaining an articulation angle between a towing vehicle and a vehicle that is coupled to the towing vehicle are available.

In addition, a combination of a motor vehicle and a mobile electronic device, independent from the motor vehicle, including a processor and a camera, and the use of an autonomous mobile electronic device, including a processor and a camera, on or in a motor vehicle, in particular as a maneuvering aid or driver assistance system when traveling with a trailer, are described in German Patent Application No. DE 10 2010 008 324 A1. It is provided that the camera is directed onto the trailer from the motor vehicle, and images of the trailer recorded by the camera are evaluated by the processor in order to ascertain a positional relationship between the motor vehicle and the trailer.

### SUMMARY

In accordance with the present invention, a method for ascertaining a relative angle between a first longitudinal axis of a towing vehicle and a second longitudinal axis of a vehicle that is mechanically coupled to the towing vehicle, a control unit and a computer program, are provided.

The present invention provides a method for ascertaining a relative angle between a first longitudinal axis of a towing vehicle and a second longitudinal axis of a vehicle that is mechanically coupled to the towing vehicle. In accordance with an example embodiment of the present invention, the method includes the following steps:
detecting a light unit situated on the vehicle with the aid of a camera unit situated on the towing vehicle in order to obtain a piece of image information of the light unit;
recognizing the light unit in the obtained image information, using an optical signal that is emitted by the detected light unit, in order to obtain a piece of position information of the light unit, the position information representing a spatial position of the light unit in the image information relative to a defined reference point;
ascertaining the relative angle between the first longitudinal axis of the towing vehicle and the second longitudinal axis of the vehicle, using the position information of the detected light unit; and
emitting a signal as a function of the ascertained relative angle.

The towing vehicle is designed to pull or push a vehicle that is mechanically coupled to the towing vehicle. The towing vehicle may be a passenger vehicle, a truck, a semi-tractor-trailer, or an agricultural machine such as a tractor. The vehicle may be a trailer, a semitrailer, or a mobile home that is mechanically coupled or mechanically connected to or trailed by the towing vehicle with the aid of a mechanical coupling. The towing vehicle and the vehicle are pivotably mechanically coupled. A spatial distance between the towing vehicle and the vehicle may be essentially constant. The towing vehicle and the vehicle may be part of a combination, for example a tractor-trailer, or may form a combination.

A longitudinal axis of a vehicle may preferably be understood to mean the longest axis of the vehicle. However, the longitudinal axis may also be an axis that is different from the longest axis. The longitudinal axis may point essentially in parallel to a travel direction of the vehicle on a roadway. A first longitudinal axis of the towing vehicle and a second longitudinal axis of the vehicle that is mechanically coupled to the towing vehicle may be oriented essentially in parallel when the towing vehicle and the vehicle are traveling straight ahead. The longitudinal axis of the vehicle may be a vehicle longitudinal axis or a travel longitudinal axis.

A relative angle between the first longitudinal axis of the towing vehicle and the second longitudinal axis of the vehicle that is mechanically coupled to the towing vehicle is an angle that is enclosed or delimited by one of the two longitudinal axes. The relative angle is preferably defined in a plane that is essentially in parallel to the roadway. As a result, the relative angle between the two longitudinal axes when the towing vehicle and the vehicle are traveling straight ahead is essentially zero, and when they are negotiating curves or carrying out a turning or maneuvering operation assumes a value different from zero. The relative angle may be a relative yaw angle or an articulation angle. The relative angle is thus used to describe a relative position or a position between the towing vehicle and the vehicle.

The vehicle includes a light unit with a light source. The light source is designed to generate and emit an optical signal, or to emit a generated optical signal. In other words, the light source is designed to generate or emit light. It is advantageous when the method provides a step of emitting the optical signal with the aid of the light unit situated at the vehicle. The optical signal or the light may be emitted repeatedly, in particular periodically or with a certain temporal pattern. The light source may emit monochromatic light or light having a spectral distribution. The light source preferably emits light in the visible, ultraviolet, or infrared electromagnetic spectral range. The light source is designed to emit the light in a preferred travel direction or in the direction of the towing vehicle. The light source may include an LED illuminant, for example.

The light unit may be an illumination unit of the vehicle. The illumination unit may be an external lighting unit, in particular a marker light, of the vehicle. The light unit may be situated at a rearward area of the vehicle, facing away from a preferred travel direction of the vehicle, or on a front area of the vehicle, facing the travel direction. Alternatively, the light unit may be situated at a side area of the vehicle.

The towing vehicle includes a camera unit. The camera unit is oriented opposite from a preferred or prevailing travel direction of the towing vehicle in order to detect the light unit that is situated at the vehicle which is mechanically coupled to the towing vehicle. The detection of the light unit may provide for generation of a piece of image information, in particular an image recording and/or video recording of the light unit. The camera unit may include a video camera or a stereocamera. The camera unit is preferably part of a mirror replacement system that is designed to replace conventional rearview mirrors, in particular outside rearview mirrors, at vehicles.

The camera unit preferably includes two individual cameras that are situated on opposite sides of the towing vehicle, symmetrically with respect to the longitudinal axis of the towing vehicle. The two cameras are designed so that each detects a portion of the towing vehicle. It is possible for the vehicle to include two spatially separate light units, and for each of the cameras to detect both or only one of the light units.

The image information of the light unit may be understood to mean an image or a recording or a light unit parameter that depicts optically detectable features, or features of the light unit that are detectable with the aid of ultraviolet or infrared radiation. The image information of the light unit may include a black and white image, an RGB image, an infrared image, and/or an ultraviolet image. The image information of the light unit may also contain information that is obtained by processing or handling of the image or recording of the light unit that is detected by an image sensor or infrared sensor or ultraviolet sensor of the camera unit. The image information may in particular include multiple successive recordings or a video recording.

The light unit is recognizable in the piece of image information, using the optical signal that is emitted by the detected light unit. It is possible for the light unit to be recognizable based on the color or the wavelength of the optical signal. It is also possible for the light unit to be recognizable based on a change in the optical signal over time. It is advantageous when the method provides a step of recognizing the light unit in at least two successive pieces of image information, using an optical signal that is emitted by the detected light unit, in order to obtain a piece of position information of the light unit.

Recognizing the light unit in the image information is understood to mean unambiguously identifying the light unit in the image information. It is possible for the recognition of the light unit to include differentiating among multiple detected light units, based on the optical signals that are emitted by the light units. The multiple light units may be situated at the vehicle that is mechanically coupled to the towing vehicle, or at other vehicles.

A piece of position information of the light unit may be obtained by recognizing the light unit in the image information. The position information represents a spatial position of the light unit in the image information relative to a defined reference point. The spatial position of the light unit in the image information may include an indication concerning pixel values. Recognizing the light unit may take place with the aid of an evaluation unit that is situated at the towing vehicle or outside the towing vehicle.

The defined reference point is a defined reference point in the image information. It is possible for the defined reference point to correspond to a spatial position of the light unit in the image information when the longitudinal axes of the towing vehicle and of the vehicle are oriented in parallel. It is also possible for the reference point to be established at the factory with the aid of calibration. It is also possible for various camera units to include various reference points.

Alternatively, the step of recognizing the light unit may provide an ascertainment of a position of the light unit relative to a defined axis of the camera unit, using the optical signal that is emitted by the detected light unit. The defined axis of the camera unit may be an optical axis of the camera unit or a reference axis of the camera unit that is established at the factory.

In addition, for recognizing the light unit, a piece of information concerning an arrangement, orientation, physical property, and/or operating mode of the light unit may be received by the control unit of the towing vehicle. The information may be emitted by a control unit of the vehicle and received by a control unit of the towing vehicle. It is also possible for the information to be input into the control unit of the towing vehicle.

The information concerning the arrangement or the spatial position of the light unit at the vehicle may be a distance relative to a longitudinal axis of the vehicle or a lateral outer wall of the vehicle. Additionally or alternatively, the information concerning the arrangement or the spatial position of the light unit at the vehicle may include a distance relative to a front end area or to a kingpin of the vehicle. In addition, the information may be a direction or an orientation of an optical axis of the light unit. The physical property of the light unit may be a wavelength, a spectrum, a frequency, or an intensity of the emitted optical signal. The operating mode may be a switch-on or a switch-off, or a defined on-and-off switching, a so-called “blinking pattern,” of the light unit.

The relative angle between the longitudinal axes of the vehicles may be ascertained based on the obtained position information of the light unit in the obtained image information. With the aid of a processing unit, it is possible to directly compute the relative angle from the spatial position of the light unit in the image information relative to the defined reference point. The processing unit may be situated at the towing vehicle or outside the towing vehicle.

In addition, the step of ascertaining the relative angle may include a step of receiving a piece of information concerning an arrangement or spatial position of the light unit at the vehicle. The information concerning the arrangement or the spatial position may be emitted by a control unit of the vehicle and received by a control unit of the towing vehicle. It is also possible for the information concerning the arrangement or the spatial position to be input into the control unit of the towing vehicle. The information concerning the arrangement or the spatial position of the light unit at the vehicle may be a distance relative to a longitudinal axis of the vehicle or a lateral outer wall of the vehicle. Additionally or alternatively, the information concerning the arrangement or the spatial position of the light unit at the vehicle may include a distance relative to a front end area or to a kingpin of the vehicle. Furthermore, the information may additionally include a piece of information concerning a direction or an orientation of an optical axis of the light unit.

A signal is emitted as a function of the ascertained relative angle. The emitted signal may be a signal for controlling a display unit, for example a display in the towing vehicle, and/or for controlling a steering system and/or braking system and/or acceleration system of the towing vehicle and/or of the vehicle. It is possible for an automated maneuvering of the vehicle to take place based on the ascertained relative angle.

The approach presented here allows an ascertainment of the relative angle between two mechanically coupled vehicles that is precise and reliable as well as simple and cost-effective. With an appropriate selection of the camera unit, in particular the suitable selection of the technical parameters such as the resolution capability, the relative angle may be determined with high accuracy. Due to the use of the optical signal for recognizing the light unit, the relative angle is robust against environmental influences such as a low sun or heavy precipitation. At the same time, the provided method is independent of complex and CPU-intensive image processing algorithms. In addition, carrying out the method requires only slight modifications to recent vehicles or towing vehicles.

It is advantageous when the example method includes a step of comparing the position information of the light unit to pieces of position information of the light unit stored in a characteristic map, in order to ascertain the relative angle. It is possible to store the particular associated image information in the characteristic map for a plurality of relative angles between the towing vehicle and the mechanically coupled vehicle. The relative angle may be ascertained by comparing the obtained image information of the light unit and the stored pieces of image information. The relative angle may be quickly and reliably ascertained via this embodiment.

It is also advantageous when the relative angle is ascertained using a piece of distance information that represents a spatial distance between the two vehicles. The spatial distance between the two vehicles may be a distance between the rear end of the towing vehicle in a preferred travel direction and a front end of the vehicle in the preferred travel direction. In particular, the distance between the position of the first longitudinal axis at the rear end of the towing vehicle and the position of the second longitudinal axis at the front end of the towing vehicle may be defined. Alternatively, the spatial distance may be a distance between the camera unit and the light unit during straight-ahead travel. The distance information may be received from a processing unit or input via an input unit or read out from a memory unit. The processing unit, the input unit, and/or the memory unit may be situated at the towing vehicle or outside the towing vehicle. The relative angle between the vehicles may be ascertained in a particularly precise manner using the distance information and the spatial position of the light unit in the image information relative to the defined reference point.

Furthermore, it is advantageous when the optical signal emitted by the light unit has a defined pattern with an intensity that is variable over time and/or a frequency that is variable over time. The light unit may be designed to emit a predefined or predefinable signal pattern. The defined pattern may be a so-called “blinking pattern,” i.e., a defined temporal sequence of switching-on and switching-off operations of the light unit. The defined pattern may have a frequency that is high enough that the defined pattern is detected only by the camera unit, and not perceived by the human eye. The defined pattern may be stored or input in the control unit of the towing vehicle or a memory unit associated with the camera unit. An identification number may be assigned to the defined pattern. The identification number of a defined pattern of an emitted optical signal may be transmitted within a communications network of the towing vehicle or of the vehicle. In addition, it is possible for the example method to provide an emission of a first optical signal having a first defined pattern, and an emission of a second optical signal, having a second defined pattern, subsequent to the first optical signal. The first optical signal having the first defined pattern may be used to initialize the method, i.e., to recognize the light unit for the first time. The second optical signal having the second defined pattern may be used to recognize the light unit in order to ascertain the relative angle. When both optical signals having the respective defined patterns are recognized, a relative angle is ascertained and a corresponding signal is emitted. Via this embodiment, the light unit may be recognized in a particularly robust and reliable manner, and confusion with other vehicles may be avoided.

It is also advantageous when the example method according of the present invention includes a step of emitting a control signal with the aid of a control unit situated at the towing vehicle in order to control the emission of the optical signal with the aid of the light unit situated at the vehicle. It is advantageous when the control signal is emitted when reverse travel of the towing vehicle is initiated, in particular when a reverse gear is engaged at the towing vehicle. It is possible for the control signal to be emitted by the towing vehicle to the vehicle in a wireless or hard-wired manner. It is also possible for an emission of the optical signal to be triggered or ended with the aid of the control signal. For example, when reverse travel of the towing vehicle is initiated, the emission of the optical signal may be triggered with the aid of the control signal, and when forward travel of the towing vehicle is initiated, the emission of the optical signal may be ended with the aid of a further control signal. A defined and targeted emission of the optical signal is ensured via this embodiment.

Alternatively, the example method according to the present invention may provide that the vehicle includes a control unit, with the aid of which the emission of the optical signal is controlled with the aid of the light unit situated at the vehicle. The step of controlling the emission of the optical signal may be triggered by a control unit of the towing vehicle. The control unit of the towing vehicle and the control unit of the vehicle may be connected to one another with the aid of a wireless or hard-wired communication link.

It is particularly advantageous when the detection of the light unit includes a detection of a first light unit situated at the vehicle and a detection of a second light unit situated at the vehicle in order to obtain a first piece of image information of the first light unit and a second piece of image information of the second light unit, the first light unit in the first piece of image information being recognized based on a first optical signal that is emitted by the first detected light unit, and the second light unit in the second piece of image information being recognized based on a second optical signal that is emitted by the second detected light unit. It is advantageous when
the second light unit is different from the first light unit and/or
the second optical signal is different from the first optical signal and/or
the second piece of image information is different from the first piece of image information.

The two light units may be situated at opposite areas of the vehicle. It is also possible for multiple light units to be situated at one or multiple sides of the vehicle. Furthermore, it is possible for the light units to emit different or individual optical signals. For example, the light unit on the right of the vehicle in a preferred travel direction may emit an optical signal with an intensity or frequency or wavelength or change over time or defined pattern or “blinking pattern” that is different from a light unit situated at the left of the vehicle. It is also possible for multiple light units situated at a first side of the vehicle to emit identical first optical signals, and for multiple light units situated at a second side of the vehicle to emit identical second optical signals that are different from the first optical signals. Confusion of the light units of adjacently traveling or maneuvering towing vehicles with mechanically coupled vehicles may thus be avoided. Accordingly, the obtained image information of the two light units may be different. Via this embodiment, ascertaining the relative angle may be improved, and may be ensured in various relative positions between the towing vehicle and the vehicle.

Moreover, it is advantageous when the camera unit is a camera unit that is already present at the towing vehicle, and/or the light unit is a light unit that is already present at the vehicle. The camera unit that is present may be the camera unit of a mirror replacement system. The light unit that is present may be an already integrated light unit. The light unit that is present may also have other intended uses. The method may thus be implemented in a particularly cost-effective manner.

### BRIEF DESCRIPTION OF THE DRAWINGS

The present invention is explained in greater detail below by way of example, with reference to the figures.

FIGS. 1A through 1F show a schematic illustration of a maneuvering tractor-trailer.

FIG. 2 shows a schematic illustration of a communication protocol according to one exemplary embodiment.

FIG. 3 shows a flow chart of a method according to one exemplary embodiment.

### DETAILED DESCRIPTION OF EXAMPLE EMBODIMENTS

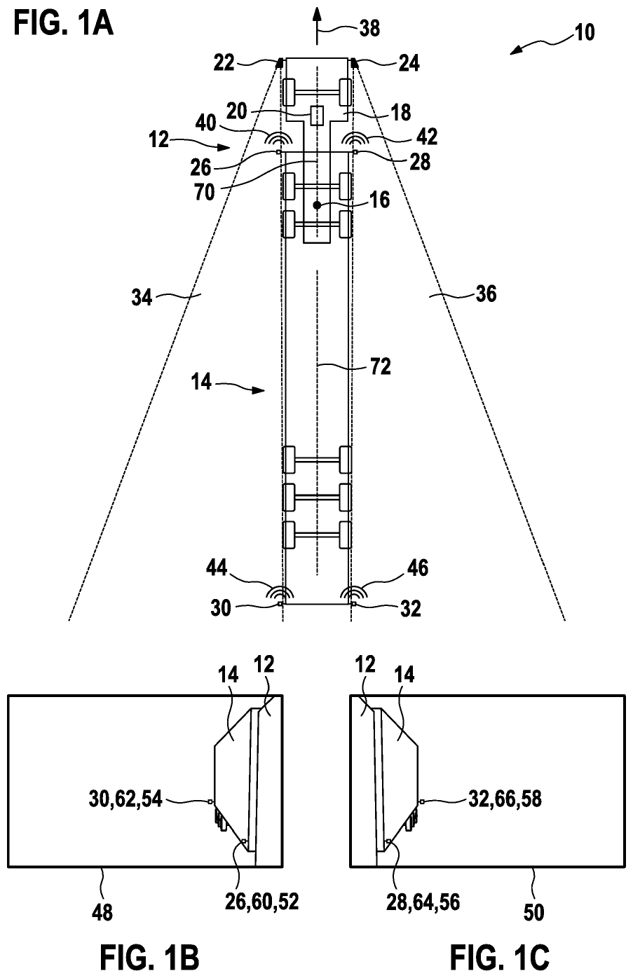

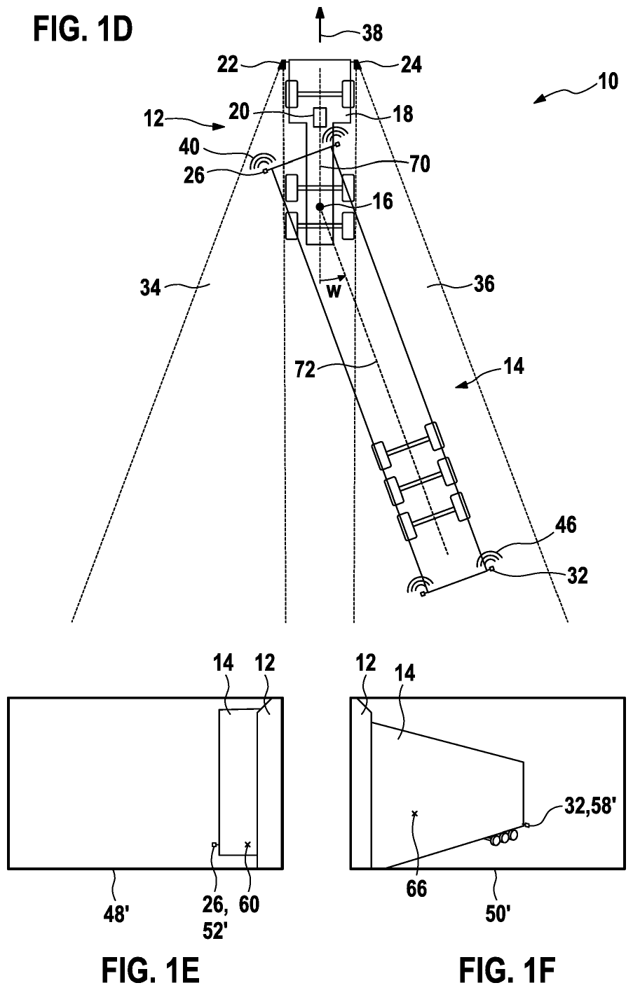

FIGS. 1A and 1D illustrate a top view onto a maneuvering tractor-trailer in accordance with an example embodiment of the present invention, which is provided overall with reference numeral 10.

Tractor-trailer 10 includes a towing machine 12 and a semitrailer 14. Semitrailer 14 is mechanically coupled to towing machine 12 with the aid of a fifth wheel coupling 16.

Towing machine 12 includes a driving cab 18, a control unit 20, and two video cameras 22, 24 that are part of a mirror replacement system of towing machine 12. Semitrailer 14 includes four marker lights 26, 28, 30, 32.

Video cameras 22, 24 are situated on the right and left sides of driving cab 18 of towing machine 12. Video cameras 22, 24 are oriented with their detection ranges 34, 36 opposite a preferred or prevailing travel direction 38 of tractor-trailer 10 in order to detect marker lights 26, 28, 30, 32 of semitrailer 14.

Two marker lights 26, 28 are situated on the right and left sides of a front area of semitrailer 14 along preferred travel direction 38. The further two marker lights 30, 32 are situated on the right and left sides of a rear area of semitrailer 14 along preferred travel direction 38. Marker lights 26, 28, 30, 32 are oriented along preferred travel direction 38 in order to emit or radiate an optical signal 40, 42, 44, 46 in the direction of towing machine 12.

Control unit 20 of towing machine 12 is designed to emit a control signal to marker lights 26, 28, 30, 32 with the aid of a hard-wired connection when reverse travel of tractor-trailer 10 opposite preferred travel direction 38 is initiated, in order to control the emission of optical signals 40, 42, 44, 46.

FIGS. 1B and 1C show image information 48, 50, obtained from left video camera 22 and right video camera 24, respectively, in the form of detected camera recordings 48, 50 at a relative position between towing machine 12 and semitrailer 14 as illustrated in FIG. 1A.

Left camera recording 48 shows left front marker light 26 and left rear marker light 30. Spatial positions 52, 54 of the two left marker lights 26, 30 are identical to respective reference points 60, 62 at the present relative position.

Analogously, right camera recording 50 shows right front marker light 28 and right rear marker light 32. Spatial positions 56, 58 of the two right marker lights 28, 32 are likewise identical to respective reference points 64, 66 at the present relative position.

Control unit 20 is designed to recognize marker lights 26, 28, 30, 32 in camera recordings 48, 50, using optical signals 40, 42, 44, 46 that are emitted by detected marker lights 26, 28, 30, 32, in order to obtain position information concerning marker lights 26, 28, 30, 32.

In addition, control unit 20 is designed to ascertain a relative angle of zero degrees between a first longitudinal axis 70 of towing machine 12 and a second longitudinal axis 72 of semitrailer 14, based on agreement of spatial positions 52, 54, 56, 58 with respective reference points 60, 62, 64, 68.

FIG. 1D illustrates tractor-trailer 10 with a relative position between towing machine 12 and semitrailer 14 which is different from the relative position shown in FIG. 1A.

FIGS. 1E and 1F once again show camera recordings 48′, 50′ detected by left video camera 22 and right video camera 24, respectively, at a relative position between towing machine 12 and semitrailer 14 as illustrated in FIG. 1D.

In this case, left camera recording 48′ shows only left front marker light 26 of semitrailer 14 due to the maneuvering of tractor-trailer 10. At the present relative position, spatial position 52′ of left front marker light 26 is different from corresponding reference point 60.

Right camera recording 50′ shows only right rear marker light 32. At the present relative position, spatial position 58′ of right rear marker light 32 is different from corresponding reference point 66.

Control unit 20 is designed to ascertain a relative angle w between first longitudinal axis 70 of towing machine 12 and second longitudinal axis 72 of semitrailer 14, based on the deviation of spatial positions 52′, 58′ from respective reference points 60, 66. Relative angle w is different from zero.

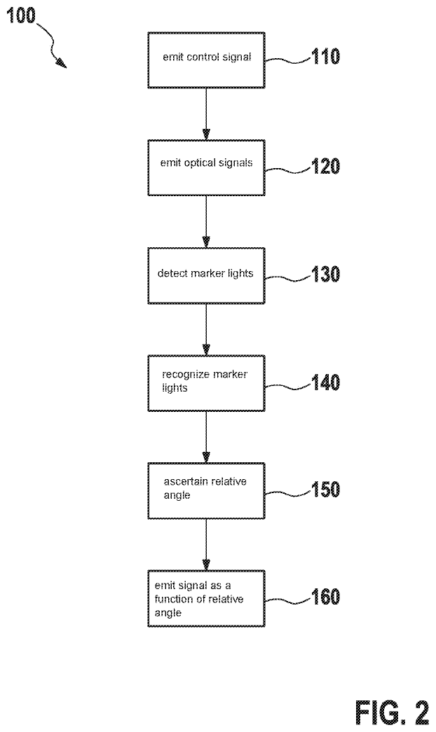

FIG. 2 shows a flow chart of one possible exemplary embodiment of a method according to the present invention for ascertaining the relative angle between first longitudinal axis 70 of towing machine 12 and second longitudinal axis 72 of semitrailer 14 which is mechanically coupled to towing machine 12.

The method is provided overall with reference numeral 100.

A control signal is emitted in step 110 with the aid of control unit 20 of towing machine 12, when a reverse gear is engaged at towing machine 12 to initiate reverse travel of tractor-trailer 10, in order to control or activate the emission of optical signals 40, 42, 44, 46 with the aid of marker lights 26, 28, 30, 32 situated at semitrailer 14.

Optical signals 40, 42, 44, 46 are emitted in step 120 with the aid of marker lights 26, 28, 30, 32 situated at semitrailer 14, optical signals 40, 42, 44, 46 emitted by marker lights 26, 28, 30, 32 each having a defined pattern, a so-called “blinking pattern,” with an intensity that is variable over time.

Marker lights 26, 28, 30, 32 situated at semitrailer 14 are detected in step 130 with the aid of video cameras 22, 24 situated at towing machine 12 in order to obtain camera recordings 48, 48′, 50, 50′ of marker lights 26, 28, 30, 32.

Marker lights 26, 28, 30, 32 in obtained camera recordings 48, 48′, 50, 50′ are recognized in step 140, using optical signals 40, 42, 44, 46 that are emitted by detected marker lights 26, 28, 30, 32, in order to obtain the position information of marker lights 26, 28, 30, 32. The position information represents spatial positions 52, 52′, 54, 56, 58, 58′ of marker lights 26, 28, 30, 32 in camera recordings 48, 48′, 50, 50′ relative to defined reference points 60, 62, 64, 66.

Relative angle w between first longitudinal axis 70 of towing machine 12 and second longitudinal axis 72 of semitrailer 14 is ascertained in step 150, using position information 52, 52′, 54, 56, 58, 58′of detected marker lights 26, 28, 30, 32.

Lastly, a signal is emitted as a function of the ascertained relative angle in step 160.

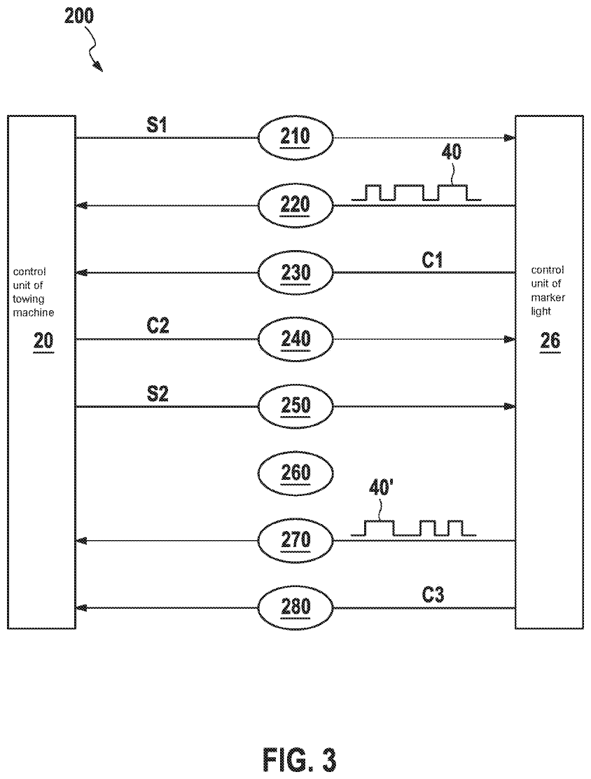

FIG. 3 schematically illustrates by way of example a communication protocol between control unit 20 of towing machine 12 and one of marker lights 26 or a control unit of marker light 26.

A control signal S1 is emitted by hard-wire from control unit 20 to the control unit of marker light 26 in step 210 when a reverse gear is engaged at towing vehicle 12, in order to activate the emission of optical signal 40 having a defined temporal pattern in step 220.

An acknowledgement signal C1 is emitted by hard-wire from the control unit of marker light 26 to control unit 20 of towing machine 12 in step 230 in order to acknowledge the emission of optical signal 40 having the defined temporal pattern.

After marker light 26 is recognized, using optical signal 40 emitted by marker light 26, an acknowledgement signal C2 is emitted by hard-wire from control unit 20 of towing machine 12 to the control unit of marker light 26 in step 240 in order to acknowledge the recognition of marker light 26.

A further control signal S2 that is different from first control signal S1 is emitted by hard-wire from control unit 20 of towing machine 12 to the control unit of marker light 26 in step 250 in order to end the emission of temporal pattern in step 260 and to activate the emission of a further optical signal 40′, having a further defined temporal pattern that is different from the defined temporal pattern, in step 270.

An acknowledgement signal C3 is emitted by hard-wire from the control unit of marker light 26 to control unit 20 of towing machine 12 in step 280 in order to acknowledge the emission of further optical signal 40′ having the further defined temporal pattern.

If an exemplary embodiment includes an “and/or” linkage between a first feature and a second feature, this is to be construed in such a way that according to one specific embodiment, the exemplary embodiment includes the first feature as well as the second feature, and according to another specific embodiment includes only the first feature or only the second feature.

1-13. (canceled)

14. A method for ascertaining a relative angle between a first longitudinal axis of a towing vehicle and a second longitudinal axis of a vehicle that is mechanically coupled to the towing vehicle, the method comprising the following steps:
detecting a light unit situated at the vehicle using a camera unit situated at the towing vehicle to obtain image information of the light unit;
recognizing the light unit in the obtained image information using an optical signal that is emitted by the detected light unit to obtain a piece of position information of the light unit, the position information representing a spatial position of the light unit in the image information relative to a defined reference point;
ascertaining the relative angle between the first longitudinal axis of the towing vehicle and the second longitudinal axis of the vehicle, using the position information of the detected light unit; and
emitting a signal as a function of the ascertained relative angle.

15. The method as recited in claim 14, further comprising the following step:
comparing the position information of the light unit to pieces of position information of the light unit stored in a characteristic map, to ascertain the relative angle.

16. The method as recited in claim 14, wherein the relative angle is ascertained using a piece of distance information that represents a spatial distance between the two vehicles.

17. The method as recited in claim 14, wherein the optical signal emitted by the light unit has a defined pattern with an intensity that is variable over time and/or a frequency that is variable over time.

18. The method as recited in claim 14, further comprising the following step:
emitting a control signal using a control unit situated at the towing vehicle to control the emission of the optical signal using the light unit situated at the vehicle.

19. The method as recited in claim 18, wherein the control signal is emitted when reverse travel of the towing vehicle is initiated when a reverse gear is engaged at the towing vehicle.

20. The method as recited in claim 14, further comprising the following step:
emitting the optical signal using the light unit situated at the vehicle.

21. The method as recited in claim 14, wherein the detection of the light unit includes a detection of a first light unit situated at the vehicle and a detection of a second light unit situated at the vehicle to obtain a first piece of image information of the first light unit and a second piece of image information of the second light unit, the first light unit in the first piece of image information being recognized based on a first optical signal that is emitted by the first detected light unit, and the second light unit in the second piece of image information being recognized based on a second optical signal that is emitted by the second detected light unit.

22. The method as recited in claim 21, wherein:
the second light unit is different from the first light unit, and/or
the second optical signal is different from the first optical signal, and/or
the second piece of image information is different from the first piece of image information.

23. The method as recited in claim 14, wherein the camera unit is a camera unit that is already present at the towing vehicle, and/or the light unit is a light unit that is already present on the vehicle.

24. A non-transitory machine-readable memory medium on which is stored a computer program, the compute program, when executed by a computer, causing the computer to perform the following:
recognize a light unit, situated at a vehicle, in image information, using an optical signal that is emitted by the light unit, to obtain position information of the light unit, the light unit having been detected using a camera unit situated at a towing vehicle that is mechanically coupled to the vehicle, the position information representing a spatial position of the light unit in the image information relative to a defined reference point; and
ascertain a relative angle between a first longitudinal axis of the towing vehicle and a second longitudinal axis f the vehicle, using the position information of the detected light unit.

25. A control unit that is configured to:
recognize a light unit, situated at a vehicle, in image information, using an optical signal that is emitted by the light unit to obtain position information of the light unit, the light unit having been detected using a camera unit situated at a towing vehicle that is mechanically coupled to the vehicle, the position information representing a spatial position of the light unit in the image information relative to a defined reference point;
ascertain a relative angle between a first longitudinal axis of the towing vehicle and a second longitudinal axis of the vehicle, using the position information of the detected light unit; and
emit a control signal as a function of the ascertained relative angle.
